(19) United States
(12) Patent Application Publication
(10) Pub. No.: US 2013/0008331 A1
(43) Pub. Date: Jan. 10, 2013

(54) LITHOGRAPHIC PRINTING PLATE PRECURSOR

(75) Inventors: Hubertus Van Aert, Pulderbos (BE); Stefaan Lingier, Wondelgem (BE); Heidi Janssens, Aarschot (BE)

(73) Assignee: AGFA GRAPHICS NV, Mortsel (BE)

(21) Appl. No.: 13/635,831

(22) PCT Filed: Mar. 2, 2011
(86) PCT No.: PCT/EP2011/053078

§ 371 Date: Sep. 18, 2012

Related U.S. Application Data
(60) Provisional application No. 61/316,416, filed on Mar. 23, 2010.

(30) Foreign Application Priority Data
Mar. 19, 2010 (EP) 10157030.7

(51) Int. Cl. B41C 1/10; B41N 3/00

(52) U.S. Cl. 101/453; 101/463.1

(57) ABSTRACT

A lithographic printing plate precursor comprising a support having a hydrophilic surface or which is provided with a hydrophilic layer, and a coating thereon, said coating comprising an IR absorbing agent and a polyvinylacetal binder, said polyvinylacetal comprising an acetal group having an acetal carbon atom substituted by a phenolic group, a naphtol group or an antracenol group, a second recurring unit comprising an acetal group having an acetal carbon atom substituted by an alkyl group having a hydrocarbon chain containing 1, 2 or 3 carbon atoms, and a third recurring unit comprising an acetal group having an acetal carbon atom substituted by an alkyl group having a hydrocarbon chain containing 1, 2 or 3 carbon atoms wherein the alkyl group of the acetal group of the third recurring unit is different from the alkyl group of the acetal group of the second recurring unit. The precursor exhibits an improved sensitivity on exposure and the stability against daylight exposure is further improved.

### FIELD OF THE INVENTION

The present invention relates to a lithographic printing plate precursor comprising an IR absorbing agent and a polyvinylacetal binder, wherein the polyvinylacetal comprises a first recurring unit comprising an acetal group having an acetal carbon atom substituted by a phenolic group, a naphtol group or an antracenol group, a second recurring unit comprising an acetal group having an acetal carbon atom substituted by an alkyl group having a hydrocarbon chain containing 1, 2 or 3 carbon atoms, and a third recurring unit comprising an acetal group having an acetal carbon atom substituted by an alkyl group having a hydrocarbon chain containing 1, 2 or 3 carbon atoms wherein the alkyl group of the acetal group of the third recurring unit is different from the alkyl group of the acetal group of the second recurring unit. The present invention relates also to a method of making a lithographic printing plate precursor comprising an IR absorbing agent and the polyvinylacetal binder. The present invention also relates to a method of making a lithographic printing plate whereby an improved sensitivity on exposure and excellent printing properties are obtained.

### BACKGROUND OF THE INVENTION

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called plate precursor. A typical positive-working plate precursor comprises a hydrophilic support and an oleophilic coating which is not readily soluble in an aqueous alkaline developer in the non-exposed state and becomes soluble in the developer after exposure to radiation. In addition to the well known photosensitive imaging materials which are suitable for UV contact exposure through a film mask (the so-called pre-sensitized plates), also heat-sensitive printing plate precursors have become very popular. Such thermal materials offer the advantage of daylight stability and are especially used in the so-called computer-to-plate method (CtP) wherein the plate precursor is directly exposed, i.e. without the use of a film mask. The material is exposed to heat or to infrared light and the generated heat triggers a (physico-)chemical process, such as ablation, polymerization, insolubilization by cross-linking of a polymer or by particle coagulation of a thermoplastic polymer latex, and solubilization by the destruction of intermolecular interactions or by increasing the penetrability of a development barrier layer.

Although some of these thermal processes enable platemaking without wet processing, the most popular thermal plates form an image by a heat-induced solubility difference in an alkaline developer between exposed and non-exposed areas of the coating. The coating typically comprises an oleophilic binder, e.g. a phenolic resin, of which the rate of dissolution in the developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support.

Typically, for a positive-working thermal plate, a dissolution inhibitor is added to a phenolic resin as binder whereby the rate of dissolution of the coating is reduced. Upon heating, this reduced rate of dissolution of the coating is increased in the exposed areas as compared with the non-exposed areas, resulting in a sufficient difference in solubility of the coating after image-wise recording by heat or IR-radiation. Many different dissolution inhibitors are known and disclosed in the literature, such as organic compounds having an aromatic group and a hydrogen bonding site or polymers or surfactants comprising siloxane or fluoroalkyl units.

The known heat-sensitive printing plate precursors typically comprise a hydrophilic support and a coating which is alkali-soluble in exposed areas (positive working material) or in non-exposed areas (negative working material) and an IR-absorbing compound. Such coating typically comprises an oleophilic polymer which may be a phenolic resin such as novolac, resol or a polyvinylphenolic resin. However, these plates suffer from a lack of resistance against press chemicals and the press life of these plates (i.e. printing run length capability) needs to be improved.

Therefore, in order to improve the press life, the phenolic resin is chemically modified whereby the phenolic monomeric unit is substituted by a group such as described in WO99/01795, EP 934 822, EP 1 072 432, U.S. Pat. No. 3,929,488, EP 2 102 443, EP 2 102 444, EP 2 102 445, EP 2 102 446. The phenolic resin can also been mixed with or replaced by another polymer such as a polyvinylacetal as described in U.S. Pat. No. 5,169,897, WO 2001/9682, EP 1 162 209, U.S. Pat. No. 6,596,460, WO 2002/73315, WO 2002/96961, U.S. Pat. No. 6,818,378, WO 2003/79113, WO 2004/20484, WO 2004/81662, EP 1 627 732, WO 2007/17162, WO 2008/103258, WO 2009/5582, WO 2009/85093 and WO 2009/99518.

As a result of the use of a polyvinylacetal or the combination of a phenolic resin with a polyvinylacetal, the printing plate precursors of the prior art suffer from a reduced sensitivity upon image-wise exposing. This means that the difference between the rate of dissolution of the exposed areas and the non-exposed areas is reduced. This may result in an insufficient removal of the coating in the exposed areas, i.e. an insufficient clean-out of the plate, and, as a result, toning may occur on the press.

### SUMMARY OF THE INVENTION

It is an aspect of the present invention to provide a heat-sensitive lithographic printing plate precursor whereby an improved sensitivity on exposure is obtained. This object is realized by the precursor defined in claim 1, having the characteristic feature that the coating on the support comprises a polyvinylacetal binder, having a first recurring unit comprising an acetal group having an acetal carbon atom substituted by a phenolic group, a naphtol group or an antracenol group, a second recurring unit comprising an acetal group having an acetal carbon atom substituted by an alkyl group having a hydrocarbon chain containing 1, 2 or 3 carbon atoms, and a third recurring unit comprising an acetal group having an acetal carbon atom substituted by an alkyl group having a hydrocarbon chain containing 1, 2 or 3 carbon atoms wherein the alkyl group of the acetal group of the third recurring unit is different from the alkyl group of the acetal group of the second recurring unit.

Other specific embodiments of the invention are defined in the dependent claims.

### DETAILED DESCRIPTION OF THE INVENTION

In accordance with the present invention, there is provided a lithographic printing plate precursor comprising a support having a hydrophilic surface or which is provided with a hydrophilic layer, and a coating thereon, said coating comprising an IR absorbing agent and a polyvinylacetal binder, having a first recurring unit comprising an acetal group having an acetal carbon atom substituted by a phenolic group, a naphtol group or an antracenol group, a second recurring unit comprising an acetal group having an acetal carbon atom substituted by an alkyl group having a hydrocarbon chain containing 1, 2 or 3 carbon atoms, and a third recurring unit comprising an acetal group having an acetal carbon atom substituted by an alkyl group having a hydrocarbon chain containing 1, 2 or 3 carbon atoms wherein the alkyl group of the acetal group of the third recurring unit is different from the alkyl group of the acetal group of the second recurring unit.

The term “acetal carbon atom” means the carbon atom which is bound to the two oxygen atoms of the acetal group and this carbon atom is also bound to the substituting phenolic, naphthol or antracenol group as defined for the first recurring unit or to the substituting alkyl group as defined for each of the second and third recurring units. When the acetal group is formed by an acetalisation reaction of an aldehyde with the hydroxyl groups of two neighbouring vinylalcohol units of a polymer comprising vinylalcohol monomeric units, this “acetal carbon atom” is defined by the carbon atom of the carbonyl group of the aldehyde.

In accordance with a preferred embodiment of the present invention, said second recurring unit comprises an acetal group having an acetal carbon atom substituted by an alkyl group having a hydrocarbon chain containing 3 carbon atoms and said third recurring unit comprises an acetal group having an acetal carbon atom substituted by an alkyl group having a hydrocarbon chain containing 1 or 2 carbon atoms.

In accordance with another preferred embodiment of the present invention, said second recurring unit comprises an acetal group having an acetal carbon atom substituted by an alkyl group having a hydrocarbon chain containing 3 carbon atoms and said third recurring unit comprises an acetal group having an acetal carbon atom substituted by an alkyl group having a hydrocarbon chain containing 2 carbon atoms.

In accordance with another preferred embodiment of the present invention, said first recurring unit comprises an acetal group having an acetal carbon atom substituted by a phenolic group.

In accordance with another preferred embodiment of the present invention, said first recurring unit comprises an acetal group having an acetal carbon atom substituted by a 2-hydroxy-phenyl group.

### Polyvinylacetal

The polyvinylacetal of the present invention is preferably soluble in an aqueous alkaline developer and comprises a first recurring unit comprising an acetal group having an acetal carbon atom substituted by a phenolic group, a naphtol group or an antracenol group, a second recurring unit comprising an acetal group having an acetal carbon atom substituted by an alkyl group having a hydrocarbon chain containing 1, 2 or 3 carbon atoms, and a third recurring unit comprising an acetal group having an acetal carbon atom substituted by an alkyl group having a hydrocarbon chain containing 1, 2 or 3 carbon atoms wherein the alkyl group of the acetal group of the third recurring unit is different from the alkyl group of the acetal group of the second recurring unit.

The first recurring unit of the polyvinylacetal comprises an acetal group having an acetal carbon atom substituted by a phenolic group, a naphtol group or an antracenol group, preferably a phenolic acetal group.

The acetal group is a cyclic acetal group preferably formed by an acetalisation reaction of the aldehyde group of a phenol aldehyde, a naphthol aldehyde or antraceol aldehyde with the hydroxyl groups of two neighbouring vinylalcohol units of a polymer comprising vinylalcohol monomeric units.

The first recurring unit is preferably represented by the following Structure I:

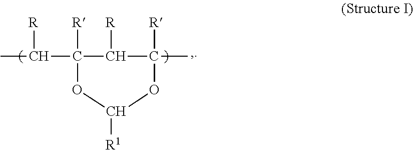

In this Structure I, R and R′ are independently hydrogen, or a substituted or unsubstituted linear or branched alkyl group having 1 to 6 carbon atoms (such as methyl, ethyl, n-propyl, n-butyl, n-pentyl, n-hexyl, chloromethyl, trichloromethyl, iso-propyl, iso-butyl, iso-pentyl, neo-pentyl, 1-methylbutyl and iso-hexyl groups), or a substituted or unsubstituted cycloalkyl ring having 3 to 6 carbon atoms in the ring (such as cyclopropyl, cyclobutyl, cyclopentyl, methyl cyclohexyl, and cyclohexyl groups), or a halo group (such as fluoro, chloro, bromo, or iodo).

In a preferred embodiment, R and R′ are independently hydrogen, or a substituted or unsubstituted methyl or chloro group, more preferably, they are independently hydrogen or an unsubstituted methyl group, most preferably they both are hydrogen.

R¹ is a substituted or unsubstituted phenol, a substituted or unsubstituted naphthol, or a substituted or unsubstituted anthracenol group. These phenol, naphthol and anthracenol groups can have optionally additional substituents including additional hydroxy substituents, methoxy, alkoxy, aryloxy, thioaryloxy, halomethyl, trihalomethyl, halo, nitro, azo, thiohydroxy, thioalkoxy, cyano, amino, carboxy, ethenyl, carboxyalkyl, phenyl, alkyl, alkenyl, alkynyl, cycloalkyl, aryl, heteroaryl, and heteroalicyclic groups. In a preferred embodiment, R¹ is an unsubstituted phenol or naphthol group such as a 2-, 3- or 4-hydroxyphenyl group or a hydroxynaphthyl group, more preferably, R¹ is an unsubstituted phenol group, most preferably, R¹ is 2-hydroxyphenyl group.

Examples of aldehydes which can be used in the acetalisation reaction for preparing an acetal group as defined for the first recurring unit are the following phenolic aldehydes: o-hydroxybenzaldehyde, 4,6-dibromo-2-formylphenol, 3,5-dichlorosalicylaldehyde, 2,4-dihydroxysalicylaldehyde, 5-nitrosalicylaldehyde, 3-methoxysalicyladehyde, 6-hydroxysalicylaldehyde, phloroglucinaldehyde, m-hydroxybenzaldehyde, 3,4-dihydroxybenzaldehyde, 3-hydroxy-4-nitrobenzaldehyde, 4-ethoxy-3-hydroxybenzaldehyde, p-hydroxybenzaldehyde, syringaldehyde, 2,4-dihydroxysalicylaldehyde, 4-hydroxy-3,5-di-tert-butylbenzaldehyde, 6-hydroxyisophthalaldehydic acid, 4-hydroxy-3-nitrobenzaldehyde and 2-anthraquinonecarboxaldehyde; the following naphthol aldehydes: 2-hydroxy-1-naphthalenealdehyde, 4-hydroxy-1-naphthalenecarbaldehyde, 1-hydroxy-2-naphthaldehyde, 6-hydroxy-2-naphthaldehyde and 1,6,7-trihydroxy-2-naphthalenecarboxaldehyde; and the following antracenol aldehydes: 1,3-dihydroxy-2-anthracenecarboxaldehyde and 2-hydroxy-1-anthracenecarboxaldehyde.

The second recurring unit of the polyvinylacetal comprises an acetal group having an acetal carbon atom substituted by an alkyl group having a hydrocarbon chain containing 1, 2 or 3 carbon atoms. In a preferred embodiment, the hydrocarbon chain comprises 2 or 3 carbon atoms, more preferably the hydrocarbon chain comprises 3 carbon atoms.

The acetal group is a cyclic acetal group preferably formed by an acetalisation reaction of the aldehyde group of an alkyl aldehyde with the hydroxyl groups of two neighbouring vinylalcohol units of a polymer comprising vinylalcohol monomeric units. The alkyl aldehyde is preferably butyraldehyde, propionaldehyde or acetaldehyde, more preferably butyraldehyde or propionaldehyde, most preferably butyraldehyde.

The second recurring unit is preferably represented by the following structure II:

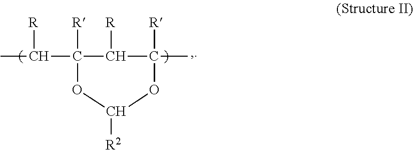

In this Structure II, R and R′ are represented by the groups as defined above for Structure I of the first recurring unit, and each of the R and R′ groups in Structure II can be the same as or different from the R and R′ groups in Structure I.

R² is a substituted or unsubstituted linear or branched alkyl group having 1 to 3 carbon atoms (such as methyl, ethyl, n-propyl or iso-propyl, chloromethyl or trichloromethyl groups).

In a preferred embodiment, R² is an unsubstituted alkyl group having 1 to 3 carbon atoms, more preferably, R² is an unsubstituted linear alkyl group having 1 to 3 carbon atoms such as methyl, ethyl or n-propyl, most preferably, R² is n-propyl.

The third recurring unit of the polyvinylacetal comprises an acetal group having an acetal carbon atom substituted by an alkyl group having a hydrocarbon chain containing 1, 2 or 3 carbon atoms and wherein the alkyl group of the acetal group of the third recurring unit is different from the alkyl group of the acetal group of the second recurring unit.

The acetal group is a cyclic acetal group preferably formed by an acetalisation reaction of the aldehyde group of an alkyl aldehyde with the hydroxyl groups of two neighbouring vinylalcohol units of a polymer comprising vinylalcohol monomeric units.

The third recurring unit is preferably represented by the following structure III:

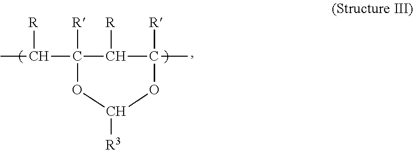

In this Structure III, R and R′ are represented by the groups as defined above for Structure I of the first recurring unit, and each of the R and R′ groups in Structure III can be the same as or different from the R and R′ groups in Structure I.

R³ is a substituted or unsubstituted linear or branched alkyl group having 1 to 3 carbon atoms (such as methyl, ethyl, n-propyl or iso-propyl, chloromethyl or trichloromethyl groups) different from the alkyl group in the second recurring unit.

In a preferred embodiment, R³ is an unsubstituted alkyl group having 1 to 3 carbon atoms, different from the alkyl group in the second recurring unit, more preferably, R³ is an unsubstituted linear alkyl group having 1 to 3 carbon atoms such as methyl, ethyl or n-propyl, different from the alkyl group in the second recurring unit, most preferably, R³ is ethyl or n-propyl, different from the alkyl group in the second recurring unit. In a more preferred embodiment, R³ is n-propyl and R² is ethyl or methyl. In a most preferred embodiment, R³ is n-propyl and R² is ethyl.

In a preferred embodiment, the polyvinylacetal of the present invention comprises the first recurring unit as defined above in an amount of at least 30 mol %, preferably in a range between 35 and 80 mol %, more preferably in a range between 40 and 70 mol %, most preferably in a range between 45 and 60 mol %.

In another preferred embodiment, the sum of the amounts (in mol % related to the complete polyvinylacetal) of the second and third recurring units in the polyvinylacetal as defined above ranges between 10 and 40 mol %, more preferably between 15 and 30 mol %, most preferably between 18 and 25 mol %.

In another preferred embodiment, the sum of the amounts (in mol % related to the complete polyvinylacetal) of the first, second and third recurring units in the polyvinylacetal as defined above ranges between 50 and 95 mol %, more preferably between 60 and 90 mol %, most preferably between 65 and 80 mol %.

In another preferred embodiment, the ratio of the amount (in mol % related to the complete polyvinylacetal) of the second recurring unit to the third recurring unit in the polyvinylacetal as defined above ranges between 100 and 0.01, more preferably between 60 and 0.02; most preferably between 30 and 0.05.

In a preferred embodiment, the ratio of the amounts (in mol % related to the complete polyvinylacetal) of the sum of the second and third recurring units to the first recurring unit in the polyvinylacetal as defined above ranges between 50 and 0.5, more preferably between 30 and 1; most preferably between 25 and 1.

In another preferred embodiment, the ratio of the amounts (in mol % related to the complete polyvinylacetal) of the first recurring unit to the sum of the second and third recurring units in the polyvinylacetal as defined above ranges between 5 and 0.5, more preferably between 4 and 0.7, most preferably between 3 and 1.

The polyvinylacetal of the present invention can have a variety of other recurring units besides the first, second and third recurring unit as defined above. In a preferred embodiment, the polyvinylacetal further comprises vinylalcohol recurring units. In another preferred embodiment, the polyvinylacetal further comprises vinylalcohol and vinylacetate recurring units.

The amount of vinylalcohol recurring units in the complete polyvinylacetal is preferably at most 50 mol %, more preferably at most 40 mol %, most preferably at most 35 mol %.

The amount of vinylacetate recurring units in the complete polyvinylacetal is preferably at most 15 mol %, more preferably at most 8 mol %, most preferably at most 3 mol %.

In a preferred embodiment, the ratio of the amount (in mol % related to the complete polyvinylacetal) of the vinylalcohol recurring unit to the vinylacetate recurring unit is preferably at most 30, more preferably at most 20, most preferably at most 15.

In another preferred embodiment, the ratio of the amount (in mol % related to the complete polyvinylacetal) of the sum of the vinylalcohol and vinylacetate recurring units to the first recurring unit ranges preferably between 1 and 0.2, more preferably between 0.8 and 0.4, most preferably between 0.7 and 0.5.

In another preferred embodiment, the ratio of the amount (in mol % related to the complete polyvinylacetal) of the sum of the vinylalcohol and vinylacetate recurring units to the sum of the second and third recurring units ranges preferably between 2 and 0.5, more preferably between 1.7 and 0.7, most preferably between 1.5 and 0.8.

In another preferred embodiment of the present invention, useful polyvinylacetals are represented by the general formula I

-(A)ₐ-(B)_{b}—(C)_{c}-(D)_{d}-(E)ₑ-,

wherein
A, B and C respectively represent recurring units as defined above by Structure I, Structure II and Structure III,
D and E respectively represent recurring units vinylalcohol and vinylacetate, and
a, b, c, d and e respectively represent the amount in mol % of the recurring units A, B, C, D and E in the polymer.

In a preferred embodiment, the polyvinylacetal has the structure of general formula I wherein

a ranges between 35 and 80 mol %, more preferably between 40 and 70 mol %, most preferably between 45 and 60 mol %,
b ranges between 5 and 35 mol %, more preferably between 7 and 30 mol %, most preferably between 10 and 25 mol %,
c ranges between 0.5 and 20 mol %, more preferably between 0.7 and 17 mol %, most preferably between 1 and 10 mol %,
d is at most 50 mol %, more preferably at most 40 mol %, most preferably at most 35 mol %, and
e is at most 15 mol %, more preferably at most 8 mol %, most preferably at most 3 mol %.

Other recurring units besides the first, second and third recurring unit as defined above and vinylalcohol and vinylacetate recurring units as mentioned above are those as disclosed in U.S. Pat. No. 5,169,897, WO 1993/3068, U.S. Pat. No. 5,534,381, U.S. Pat. No. 5,698,360, JP 11-212252, JP 11-231535, JP 2000-039707, JP 2000-275821, JP 2000-275823, U.S. Pat. No. 6,087,066, WO 2001/9682, U.S. Pat. No. 6,270,933, U.S. Pat. No. 6,596,460, WO 2002/73315, WO 2002/96961, U.S. Pat. No. 6,818,378, WO 2004/20484, WO 2007/3030, WO 2009/5582 or WO 2009/99518.

The polyvinylacetals described herein can be prepared using known starting materials and reaction conditions including those described in U.S. Pat. No. 6,541,181. For example, acetalization of the polyvinylalcohols takes place according to known standard methods for example as described in U.S. Pat. No. 4,665,124, U.S. Pat. No. 4,940,646, U.S. Pat. No. 5,169,898, U.S. Pat. No. 5,700,619, U.S. Pat. No. 5,792,823, U.S. Pat. No. 5,849,842, WO 93/03068, DE 10011096; DE 3404366, U.S. Ser. No. 09/751,660, WO 01/09682, WO 03/079113, WO 2004/081662, WO 2004/020484, WO 2008/103258, and in JP 09-328,519. This acetalization reaction generally requires addition of a strong inorganic or organic catalyst acid. Examples of catalyst acids are hydrochloric acid, sulfuric acid, phosphoric acid, and p-toluenesulfonic acid. Other strong acids are also useful such as perfluoroalkylsulfonic acid and other perfluoro-activated acids. The amount of acid should effectively allow protonation to occur, but will not significantly alter the final product by causing unwanted hydrolysis of the acetal groups. The reaction temperature of the acetalization depends on the kind of aldehyde as well as the desired level of substitution. It is between 0° C. and, if applicable, the boiling point of the solvent. Organic solvents as well as mixtures of water with organic solvents are used for the reaction. For example, suitable organic solvents are alcohols (such as methanol, ethanol, propanol, butanol, and glycol ether), cyclic ethers (such as 1,4-dioxane), and dipolar aprotic solvents (such as N,N-dimethylformamid, N-methylpyrrolidone or dimethyl sulfoxide). If acetalization is carried out in organic solvents or mixtures of organic solvents with water, the reaction product often remains in solution even if the starting polyvinyl alcohol was not completely dissolved. Incomplete dissolution of the starting polyvinylalcohol in organic solvents is a disadvantage that may lead to irreproducible degree of conversion and different products. Water or mixtures of organic solvents with water should be used to achieve complete dissolution of polyvinylalcohol and reproducible products as a result of acetalization. The sequence of the addition of the various acetalization agents is often of no importance and comparable finished products are obtained from different preparation sequences. To isolate the finished products as a solid, the polymer is solution is introduced into a non-solvent under vigorous stirring, filtered off and dried. Water is especially suitable as a non-solvent for the polymers. Unwanted hydrolysis of the acetal group achieved by acetalization with hydroxyl-substituted aromatic aldehydes takes place much easier than for the acetals built from aliphatic or non-substituted aromatic aldehydes or from aldehydes containing carboxylic moieties under the same synthesis conditions. The presence of even a small amount of water in the reaction mixture leads to a decreased degree of acetalization and incomplete conversion of the aromatic hydroxy aldehyde used. On the other hand, it was found that in the absence of water, the hydroxy-substituted aromatic aldehydes react with hydroxyl groups of alcohols immediately and with almost 100% conversion. So, the process of acetalization of polyvinyl alcohols by hydroxy-substituted aromatic aldehydes to achieve the desired polyvinyl acetals can be carried out in a way that is different from the procedures known in the art. The water can be removed from the reaction mixture during the synthesis by distillation under reduced pressure and replaced with an organic solvent. The remaining water may be removed by addition to the mixture an organic material readily reactive with water and as a result of the reaction producing volatile materials or inert compounds. These materials may be chosen from carbonates, orthoesters of carbonic or carboxylic acids, which easily react with water, silica-containing compounds, such as diethylcarbonate, trimethyl orthoformate, tetraethyl carbonate, and tetraethyl silicate. The addition of these materials to reaction mixture leads to 100% conversion of the used aldehydes.

Thus, the preparation of a useful polyvinylacetal can begin with dissolving of the starting polyvinyl alcohol in DMSO at 80-90° C., then the solution is chilled to 60° C. and the acidic catalyst dissolved in an organic solvent is added. Then the solution of the aliphatic aldehyde in the same solvent is added to the solution, the solution is kept for 30 minutes at 60° C. and a solution of the aromatic aldehyde and/or carboxylic substituted aldehyde, or other aldehyde in the same solvent is added. Anisole is added to the reaction mixture, and the azeothropic mixture of water with the anisole is removed by distillation and is replaced by the organic solvent. At this stage, the conversion of the aromatic hydroxy aldehyde reaches 95-98%. The acid in the reaction mixture is neutralized and the mixture is blended with water to precipitate the polymer that is filtrated, washed with water, and dried. A second way to achieve 100% of conversion of the aromatic hydroxyaldehyde is to add the water removing organic material (for example, a carbonate or orthoformate) after addition of the aldehydes to the reaction mixture.

### Support

The support of the lithographic printing plate precursor has a hydrophilic surface or is provided with a hydrophilic layer. The support may be a sheet-like material such as a plate or it may be a cylindrical element such as a sleeve which can be slid around a print cylinder of a printing press. A preferred support is a metal support such as aluminum or stainless steel. The metal can also be laminated to a plastic layer, e.g. polyester film.

A particularly preferred lithographic support is an electrochemically grained and anodized aluminum support. Graining and anodization of aluminum is well known in the art. The anodized aluminum support may be treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde. It is further evident that one or more of these post treatments may be carried out alone or in combination. More detailed descriptions of these treatments are given in GB-A 1 084 070, DE-A 4 423 140, DE-A 4 417 907, EP-A 659 909, EP-A 537 633, DE-A 4 001 466, EP-A 292 801, EP-A 291 760 and U.S. Pat. No. 4,458,005.

### Coating

The heat-sensitive coating, which is provided on the support, comprises an infrared absorbing agent and a polyvinylacetal binder as defined above. The coating preferably further comprises a developability enhancing compound. The coating preferably further comprises another binder than a polyvinylacetal as defined above.

The coating may be positive-working or negative-working. A positive-working heat-sensitive coating is preferred. The coating of a positive-working heat-sensitive plate precursor does not dissolve in an alkaline developing solution in the unexposed areas and becomes soluble in the exposed areas within the time used for developing the plate. The coating may be composed of one layer. In another embodiment, the coating may comprise several layers. In another embodiment, the coating comprises two layers, each of them having a different composition.

### Developability Enhancing Compound

Suitable developability enhancing compounds are: the compounds which upon being heated release gas as disclosed in WO 2003/79113, the developability enhancing compounds as disclosed in WO 2004/81662, the developability enhancing compositions that comprises one or more nitrogen-containing organic compounds as disclosed in WO 2008/103258 and the organic compounds having at least one amino group and at least one carboxylic acid group as disclosed in WO 2009/85093.

Examples of basic nitrogen-containing organic compounds useful in the developability-enhancing compositions are N-(2-hydroxyethyl)-2-pyrrolidone, 1-(2-hydroxyethyl)piperazine, N-phenyldiethanolamine, triethanolamine, 2-[bis(2-hydroxyethyl)amino]-2-hydroxymethyl-1.3-propanediol, N,N,N′,N′-tetrakis(2-hydroxyethyl)-ethylenediamine, N,N,N′,N′-tetrakis(2-hydroxypropyl)-ethylenediamine, 3-[(2-hydroxyethyl)phenylamino]propionitrile, and hexahydro-1,3,5-tris(2-hydroxyethyl)-s-triazine. Mixtures of two or more of these compounds are also useful. The basic nitrogen-containing organic compounds can be obtained from a number of commercial sources including BASF (Germany) and Aldrich Chemical Company (Milwaukee, Wis.).

In an embodiment of the present invention, the coating preferably comprises N-(2-hydroxyethyl)-2-pyrrolidone, 1-(2-hydroxyethyl)piperazine, N-phenyldiethanolamine, triethanolamine, 2-[bis(2-hydroxyethyl)amino]-2-hydroxymethyl-1.3-propanediol, N,N,N′,N′-tetrakis(2-hydroxyethyl)-ethylenediamine, N,N,N′,N′-tetrakis(2-hydroxypropyl)-ethylenediamine, 3-[(2-hydroxyethyl)phenylamino]propionitrile, and hexahydro-1,3,5-tris(2-hydroxyethyl)-s-triazine, more preferably N,N,N′,N′-tetrakis(2-hydroxypropyl)-ethylenediamine.

The basic nitrogen-containing organic compound(s) is present in the coating in an amount of from 1 to 30 weight percent, and typically from 3 to 15 weight percent, based on the total solids of the coating composition.

As noted above, these basic nitrogen-containing organic compounds may be used alone, but they are also useful in any combination of two or more.

It is also possible to use one or more of these basic nitrogen-containing organic compounds in combination with one or more acidic developability-enhancing compounds, such as carboxylic acids or cyclic acid anhydrides, sulfonic acids, sulfinic acids, alkylsulfuric acids, phosphonic acids, phosphinic acids, phosphonic acid esters, phenols, sulfonamides, or sulfonimides, since such a combination may permit further improved developing latitude and printing durability. Representative examples of such compounds are provided in [0030] to [0036] of U.S. Patent Application Publication 2005/0214677 that is cited herein with respect to these acid developability-enhancing compounds. Such compounds may be present in an amount of from 0.1 to 30 weight percent based on the total dry weight of the coating composition.

In some instances, at least two of these acidic developability-enhancing compounds are used in combination with one or more (such as two) of the basic-nitrogen-containing organic compounds described above.

In the combinations of the basic and acidic compounds described above, the molar ratio of one or more basic nitrogen-containing organic compounds to one or more acidic developability-enhancing compounds is generally from 0.1:1 to 10:1 and more typically from 0.5:1 to 2:1.

### Other Binder

In a preferred embodiment of the present invention, said coating further comprises another binder which is a phenolic resin. Said phenolic resin is an alkaline soluble oleophilic resin whereof the solubility in an alkaline developing solution is reduced in the coating and whereof the solubility in an alkaline developing solution is increased upon heating or IR-radiation.

The coating preferably further comprises a dissolution inhibitor whereby the rate of dissolution in an alkaline developing solution is reduced. Due to this solubility differential the rate of dissolution of the exposed areas is sufficiently higher than in the non-exposed areas.

The phenolic resin is preferably a novolac, a resol or a polyvinylphenolic resin; novolac is more preferred. Typical examples of such polymers are described in DE-A-4007428, DE-A-4027301 and DE-A-4445820. Other preferred polymers are phenolic resins wherein the phenyl group or the hydroxy group of the phenolic monomeric unit are chemically modified with an organic substituent as described in EP 894 622, EP 901 902, EP 933 682, WO 99/63407, EP 934 822, EP 1 072 432, U.S. Pat. No. 5,641,608, EP 982 123, WO99/01795, WO 04/035310, WO 04/035686, WO 04/035645, WO 04/035687 or EP 1 506 858.

The novolac resin or resol resin may be prepared by polycondensation of at least one member selected from aromatic hydrocarbons such as phenol, o-cresol, p-cresol, m-cresol, 2,5-xylenol, 3,5-xylenol, resorcinol, pyrogallol, bisphenol, bisphenol A, trisphenol, o-ethylphenol, p-etylphenol, propylphenol, n-butylphenol, t-butylphenol, 1-naphtol and 2-naphtol, with at least one aldehyde or ketone selected from aldehydes such as formaldehyde, glyoxal, acetoaldehyde, propionaldehyde, benzaldehyde and furfural and ketones such as acetone, methyl ethyl ketone and methyl isobutyl ketone, in the presence of an acid catalyst. Instead of formaldehyde and acetaldehyde, paraformaldehyde and paraldehyde may, respectively, be used. In a preferred embodiment of the present invention, the novolac resin is a p-cresol/formaldehyde condensation polymer.

The weight average molecular weight, measured by gel permeation chromatography using universal calibration and polystyrene standards, of the novolac resin is preferably from 500 to 150,000 g/mol, more preferably from 1,500 to 50,000 g/mol.

The poly(vinylphenol) resin may also be a polymer of one or more hydroxy-phenyl containing monomers such as hydroxystyrenes or hydroxy-phenyl (meth)acrylates. Examples of such hydroxystyrenes are o-hydroxystyrene, m-hydroxystyrene, p-hydroxystyrene, 2-(o-hydroxyphenyl)propylene, 2-(m-hydroxyphenyl)propylene and 2-(p-hydroxyphenyl)propylene. Such a hydroxystyrene may have a substituent such as chlorine, bromine, iodine, fluorine or a C₁₋₄ alkyl group, on its aromatic ring. An example of such hydroxy-phenyl (meth)acrylate is 2-hydroxy-phenyl methacrylate.

The poly(vinylphenol) resin may usually be prepared by polymerizing one or more hydroxy-phenyl containing monomer in the presence of a radical initiator or a cationic polymerization initiator. The poly(vinylphenol) resin may also be prepared by copolymerizing one or more of these hydroxy-phenyl containing monomers with other monomeric compounds such as acrylate monomers, methacrylate monomers, acrylamide monomers, methacrylamide monomers, vinyl monomers, aromatic vinyl monomers or diene monomers.

The weight average molecular weight, measured by gel permeation chromatography using universal calibration and polystyrene standards, of the poly(vinylphenol) resin is preferably from 1.000 to 200,000 g/mol, more preferably from 1,500 to 50,000 g/mol.

Examples of phenolic resins are:
POL-01: ALNOVOL™ SPN452 is a solution of a novolac resin, 40% by weight in Dowanol™ PM, obtained from CLARIANT GmbH.
Dowanol™ PM consists of 1-methoxy-2-propanol (>99.5%) and 2-methoxy-1-propanol (<0.5%).
POL-02: ALNOVOL™ SPN400 is a solution of a novolac resin, 44% by weight in Dowanol™ PMA, obtained from CLARIANT GmbH.
Dowanol™ PMA consists of 2-methoxy-1-methyl-ethylacetate.
POL-03: ALNOVOL™ HPN100 a novolac resin obtained from CLARIANT GmbH.
POL-04: DURITE™ PD443 is a novolac resin obtained from BORDEN CHEM. INC.
POL-05: DURITE™ SD423A is a novolac resin obtained from BORDEN CHEM. INC.
POL-06: DURITE™ SD126A is a novolac resin obtained from BORDEN CHEM. INC.
POL-07: BAKELITE™ 6866LB02 is a novolac resin obtained from BAKELITE AG.
POL-08: BAKELITE™ 6866LB03 is a novolac resin obtained from BAKELITE AG.
POL-09: KR 400/8 is a novolac resin obtained from KOYO CHEMICALS INC.
POL-10: HRJ 1085 is a novolac resin obtained from SCHNECTADY INTERNATIONAL INC.
POL-11: HRJ 2606 is a phenol novolac resin obtained from SCHNECTADY INTERNATIONAL INC.
POL-12: LYNCUR™ CMM is a copolymer of 4-hydroxy-styrene and methyl methacrylate obtained from SIBER HEGNER.

In another preferred embodiment of the present invention, the binder of the coating is insoluble in water and soluble in an alkaline solution, such as an organic polymer which has acidic groups with a pKa of less than 13 to ensure that the layer is soluble or at least swellable in aqueous alkaline developers. Advantageously, the binder is a polymer or polycondensate, for example a polyester, a polyamide resin, an epoxy resin, an acrylic resin, a methacrylic resin, a styrene based resin, a polyurethane resin or polyurea. The polymer may have one or more functional groups selected from a sulfonamide group, an active imide group, a carboxyl group, a sulfonic group or a phosphoric group.

In another embodiment of the present invention, said other binder of the coating is a polymer comprising at least one sulfonamide group. The sulphonamide polymer may further comprise one or more other monomeric units, preferably selected from an alkyl or aryl (meth)acrylate such as methyl (meth)acrylate, ethyl (meth)acrylate, butyl (meth)acrylate, benzyl (meth)acrylate, 2-phenylethyl (meth)acrylate, hydroxylethyl (meth)acrylate, phenyl (meth)acrylate; (meth)acrylic acid; (meth)acrylamide; a N-alkyl or N-aryl (meth)acrylamide such as N-methyl (meth)acrylamide, N-ethyl (meth) acrylamide, N-phenyl (meth) acrylamide, N-benzyl (meth)acrylamide, N-methylol (meth)acrylamide, N-(4-hydroxyphenyl)(meth)acrylamide, N-(4-methylpyridyl)(meth)acrylate; (meth)acrylonitrile; styrene; a substituted styrene such as 2-, 3- or 4-hydroxy-styrene, 4-benzoic acid-styrene; a vinylpyridine such as 2-vinylpyridine, 3-vinylpyridine, 4-vinylpyridine; a substituted vinylpyridine such as 4-methyl-2-vinylpyridine; vinyl acetate, to optionally the copolymerised vinyl acetate monomeric units are at least partially hydrolysed, forming an alcohol group, and/or at least partially reacted by an aldehyde compound such as formaldehyde or butyraldehyde, forming an acetal or butyral group; vinyl alcohol; vinyl acetal; vinyl butyral; a vinyl ether such as methyl vinyl ether; vinyl amide; a N-alkyl vinyl amide such as N-methyl vinyl amide, caprolactame, vinyl pyrrolydone; maleimide; a N-alkyl or N-aryl maleimide such as N-benzyl maleimide.

The sulphonamide (co)polymers may be linear or branched and may contain the comonomers ad random distributed. The polymers may also be a block or graft copolymer containing chain segments of a specific monomer.

In another embodiment of the present invention, said coating may comprise other polymers having an active imide group such as —SO₂—NH—CO—R^{h}, —SO₂—NH—SO₂—R^{h} or —CO—NH—SO₂—R^{h} wherein R^{h} represents an optionally substituted hydrocarbon group such as an optionally substituted alkyl, aryl, alkaryl, aralkyl or heteroaryl group. Polymers comprising a N-benzyl-maleimide monomeric unit can also be added to the coating and can be selected from the polymers as described in EP-A 933 682, EP 0 894 622 (page 3 line 16 to page 6 line 30), EP-A 0 982 123 (page 3 line 56 to page 51 line 5), EP-A 1 072 432 (page 4 line 21 to page 10 line 29) and WO 99/63407 (page 4 line 13 to page 9 line 37).

In another embodiment of the present invention, said coating may comprise other polymers having an acidic group which can be selected from polycondensates and polymers having free phenolic hydroxyl groups, as obtained, for example, by reacting phenol, resorcinol, a cresol, a xylenol or a trimethylphenol with aldehydes, especially formaldehyde, or ketones. Condensates of sulfamoyl- or carbamoyl-substituted aromatics and aldehydes or ketones can also be added to the coating. Polymers of bismethylol-substituted ureas, vinyl ethers, vinylamides and polymers of phenylacrylates and copolymers of hydroxy-phenylmaleimides are likewise suitable to add to the coating. Furthermore, polymers having units of vinylaromatics, N-aryl(meth)acrylamides or aryl (meth)acrylates may also be added to the coating, it being possible for each of these units also to have one or more carboxyl groups, phenolic hydroxyl groups, sulfamoyl groups or carbamoyl groups. Specific examples include polymers having units of 2-hydroxyphenyl (meth)acrylate, of N-(4-hydroxyphenyl)(meth)acrylamide, of N-(4-sulfamoylphenyl)-(meth)acrylamide, of N-(4-hydroxy-3,5-dimethylbenzyl)-(meth)acrylamide, or 4-hydroxystyrene or of hydroxyphenylmaleimide. The polymers may additionally contain units of other monomers which have no acidic units. Such units include vinylaromatics, methyl (meth)acrylate, phenyl(meth)acrylate, benzyl (meth)acrylate, methacrylamide or acrylonitrile.

### Dissolution Inhibitor

In a preferred embodiment of the present invention, the heat-sensitive coating or a layer of the heat-sensitive coating also contain one or more dissolution inhibitors. Dissolution inhibitors are compounds which reduce the dissolution rate of the hydrophobic polymer in the aqueous alkaline developer at the non-exposed areas of the coating and wherein this reduction of the dissolution rate is destroyed by the heat generated during the exposure so that the coating readily dissolves in the developer at exposed areas. The dissolution inhibitor exhibits a substantial latitude in dissolution rate between the exposed and non-exposed areas. By preference, the dissolution inhibitor has a good dissolution rate latitude when the exposed coating areas have dissolved completely in the developer before the non-exposed areas are attacked by the developer to such an extent that the ink-accepting capability of the coating is affected. The dissolution inhibitor(s) can be added to the layer which comprises the hydrophobic polymer discussed above.

The dissolution rate of the non-exposed coating in the developer is preferably reduced by interaction between the hydrophobic polymer and the inhibitor, due to e.g. hydrogen bonding between these compounds. Suitable dissolution inhibitors are preferably organic compounds which comprise at least one aromatic group and a hydrogen bonding site, e.g. a carbonyl group, a sulfonyl group, or a nitrogen atom which may be quaternized and which may be part of a heterocyclic ring or which may be part of an amino substituent of said organic compound. Suitable dissolution inhibitors of this type have been disclosed in e.g. EP-A 825 927 and 823 327.

Water-repellent polymers represent an another type of suitable dissolution inhibitors. Such polymers seem to increase the developer resistance of the coating by repelling the aqueous developer from the coating. The water-repellent polymers can be added to the layer comprising the first polymer and/or can be present in a separate layer provided on top of the layer with the first polymer. In the latter embodiment, the water-repellent polymer forms a barrier layer which shields the coating from the developer and the solubility of the barrier layer in the developer or the penetrability of the barrier layer by the developer can be increased by exposure to heat or infrared light, as described in e.g. EP-A 864420, EP-A 950 517 and WO99/21725. Preferred examples of the water-repellent polymers are polymers comprising siloxane and/or perfluoroalkyl units. In one embodiment, the coating contains such a water-repellent polymer in an amount between 0.5 and 25 mg/m², preferably between 0.5 and 15 mg/m² and most preferably between 0.5 and 10 mg/m². When the water-repellent polymer is also ink-repelling, e.g. in the case of polysiloxanes, higher amounts than 25 mg/m² can result in poor ink-acceptance of the non-exposed areas. An amount lower than 0.5 mg/m² on the other hand may lead to an unsatisfactory development resistance. The polysiloxane may be a linear, cyclic or complex cross-linked polymer or copolymer. The term polysiloxane compound shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the (co)polymer is at least 2, preferably at least 10, more preferably at least 20. It may be less than 100, preferably less than 60. In another embodiment, the water-repellent polymer is a block-copolymer or a graft-copolymer of a poly(alkylene oxide) block and a block of a polymer comprising siloxane and/or perfluoroalkyl units. A suitable copolymer comprises about 15 to 25 siloxane units and 50 to 70 alkylene oxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. Such a copolymer acts as a surfactant which upon coating, due to its bifunctional structure, automatically positions itself at the interface between the coating and air and thereby forms a separate top layer even when the whole coating is applied from a single coating solution. Simultaneously, such surfactants act as a spreading agent which improves the coating quality. Alternatively, the water-repellent polymer can be applied in a second solution, coated on top of the layer comprising the hydrophobic polymer. In that embodiment, it may be advantageous to use a solvent in the second coating solution that is not capable of dissolving the ingredients present in the first layer so that a highly concentrated water-repellent phase is obtained at the top of the coating.

### Development Accelerator

Preferably, also one or more development accelerators are included in the heat-sensitive coating or in a layer of the heat-sensitive coating, i.e. compounds which act as dissolution promoters because they are capable of increasing the dissolution rate of the non-exposed coating in the developer. The simultaneous application of dissolution inhibitors and accelerators allows a precise fine tuning of the dissolution behavior of the coating. Suitable dissolution accelerators are cyclic acid anhydrides, phenols or organic acids. Examples of the cyclic acid anhydride include phthalic anhydride, tetrahydrophthalic anhydride, hexahydrophthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″,4″-tetrahydroxy-3,5,3′,5′-tetramethyltriphenyl-methane, and the like. Examples of the organic acids include sulfonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight, relative to the coating as a whole.

In a negative-working printing plate precursor, the heat-sensitive coating at the non-exposed areas dissolves in an alkaline developing solution and defines non-image (non-printing) areas, and the exposed areas of the coating become insoluble within the time used for developing the plate and define the image (printing) areas. According to the present invention, the heat-sensitive coating comprises an infrared absorbing agent and a polyvinylacetal binder as defined above.

The negative-working coating further comprises preferably a latent Brönsted acid which produces acid upon heating or IR radiation and a polymer. Said polymer is preferably a phenolic resin. The acid catalyzes crosslinking of the coating, optionally in a post-exposure heating step, and thus hardening of the exposed regions. Accordingly, the non-exposed regions can be washed away by a developer to reveal the hydrophilic substrate underneath. For a more detailed description of such a negative-working printing plate precursor we refer to U.S. Pat. No. 6,255,042 and U.S. Pat. No. 6,063,544 and to references cited in these documents.

The negative-working coating may comprise at least one layer. In another embodiment, the coating may comprise a first layer and a second layer, the first layer being present between the hydrophilic surface of the support and the second layer. Optionally, the coating may further comprise a first intermediate layer between the hydrophilic support and the first layer and/or a second intermediate layer between the first layer and the second layer.

### Exposure

The material can be image-wise exposed directly with heat, e.g. by means of a thermal head, or indirectly by infrared light, which is preferably converted into heat by an infrared light absorbing compound, which may be a dye or pigment having an absorption maximum in the infrared wavelength range. The infrared light absorbing dye or pigment is preferably present in the heat-sensitive coating or in a layer of the heat-sensitive coating and typically in a concentration ranging between 0.25 and 10.0 wt. %, more preferably between 0.5 and 7.5 wt. % relative to the coating as a whole. Preferred IR-absorbing compounds are dyes such as cyanine or merocyanine dyes or pigments such as carbon black. A suitable compound is the following infrared dye IR-1:

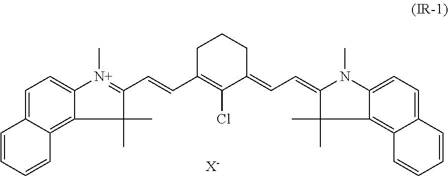

wherein X⁻ is a suitable counter ion such as tosylate.

The heat-sensitive coating or a layer of the heat-sensitive coating may further contain an organic dye which absorbs visible light so that a perceptible image is obtained upon image-wise exposure and subsequent development. Such a dye is often called contrast dye or indicator dye. Preferably, the dye has a blue color and an absorption maximum in the wavelength range between 600 nm and 750 nm. Although the dye absorbs visible light, it preferably does not sensitize the printing plate precursor, i.e. the coating does not become more soluble in the developer upon exposure to visible light. Suitable examples of such a contrast dye are the quaternized triarylmethane dyes.

According to a preferred embodiment, the contrast dye is present in the heat-sensitive coating or in a layer of the heat-sensitive coating.

According to a highly preferred embodiment, the infrared light absorbing compound is concentrated in the heat-sensitive coating or a layer of the heat-sensitive coating.

The printing plate precursor of the present invention can be exposed to infrared light with LEDs or a laser. Preferably, a laser emitting near infrared light having a wavelength in the range from about 750 to about 1500 nm is used, such as a semiconductor laser diode, a Nd:YAG or a Nd:YLF laser. The required laser power depends on the sensitivity of the image-recording layer, the pixel dwell time of the laser beam, which is determined by the spot diameter (typical value of modern plate-setters at 1/e² of maximum intensity: 10-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) platesetters. ITD platesetters for thermal plates are typically characterized by a very high scan speed up to 500 m/sec and may require a laser power of several Watts. XTD platesetters for thermal plates having a typical laser power from about 200 mW to about 1 W operate at a lower scan speed, e.g. from 0.1 to 10 m/sec.

The known platesetters can be used as an off-press exposure apparatus, which offers the benefit of reduced press down-time. XTD platesetter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368.

In the development step, the non-image areas of the coating are removed by immersion in an aqueous alkaline developer, which may be combined with mechanical rubbing, e.g. by a rotating brush. The developer comprises an alkaline agent which may be an inorganic alkaline agent such as an alkali metal hydroxide, an organic alkaline agent such as an amine, and/or an alkaline silicate such as an alkali metal silicate or an alkali metal metasilicate. The developer preferably has a pH above 10, more preferably above 12. The developer may further contain components such as a buffer substance, a complexing agent, an antifoaming agent, an organic solvent, a corrosion inhibitor, a dye, an antisludge agent, a dissolution preventing agent such as a non-ionic surfactant, an anionic, cationic or amphoteric surfactant and/or a hydrotropic agent as known in the art. The developer may further contain a poly hydroxyl compound such as e.g. sorbitol, preferably in a concentration of at least 40 g/l, and also a polyethylene oxide containing compound such as e.g. Supronic B25, commercially available from RODIA, preferably in a concentration of at most 0.15 g/l.

The development step may be followed by a rinsing step and/or a gumming step. The gumming step involves post-treatment of the lithographic printing plate with a gum solution. A gum solution is typically an aqueous liquid which comprises one or more surface protective compounds that are capable of protecting the lithographic image of a printing plate against contamination or damaging. Suitable examples of such compounds are film-forming hydrophilic polymers or surfactants.

The plate precursor can, if required, be post-treated with a suitable correcting agent or preservative as known in the art. To increase the resistance of the finished printing plate and hence to extend the run length, the layer can be briefly heated to elevated temperatures (“baking”). The plate can be dried before baking or is dried during the baking process itself. During the baking step, the plate can be heated at a temperature which is higher than the glass transition temperature of the heat-sensitive coating, e.g. between 100° C. and 230° C. for a period of 40 seconds to 5 minutes. Baking can be done in conventional hot air ovens or by irradiation with lamps emitting in the infrared or ultraviolet spectrum. As a result of this baking step, the resistance of the printing plate to plate cleaners, correction agents and UV-curable printing inks increases. Such a thermal post-treatment is described, inter alia, in DE 1,447,963 and GB 1,154,749.

The printing plate thus obtained can be used for conventional, so-called wet offset printing, in which ink and an aqueous dampening liquid is supplied to the plate. Another suitable printing method uses so-called single-fluid ink without a dampening liquid. Suitable single-fluid inks have been described in U.S. Pat. No. 4,045,232; U.S. Pat. No. 4,981,517 and U.S. Pat. No. 6,140,392. In a most preferred embodiment, the single-fluid ink comprises an ink phase, also called the hydrophobic or oleophilic phase, and a polyol phase as described in WO 00/32705.

### EXAMPLES

### Invention Examples 1 to 3 and Comparative Examples 1 to 4

### Preparation of the Lithographic Support

A 0.3 mm thick aluminium foil was degreased by immersing the foil in an aqueous solution containing 34 g/l NaOH at 70° C. for 6 seconds and rinsed with demineralised water for 3.6 seconds. The foil was then electrochemically grained during 8 seconds using an alternating current in an aqueous solution containing 15 g/l HCl, 15 g/1 SO₄²⁻ ions and 5 g/l Al³⁺ ions at a temperature of 37° C. and a current density of about 100 A/dm² (charge density of about 800 C/dm²). The aluminium foil was then desmutted by etching with an aqueous solution containing 145 g/l of sulfuric acid at 80° C. for 5 seconds and rinsed with demineralised water for 4 seconds. The foil was subsequently subjected to anodic oxidation during 10 seconds in an aqueous solution containing 145 g/l of sulfuric acid at a temperature of 57° C. and a current density of 25 A/dm² (charge density of 250 C/dm²), then washed with demineralised water for 7 seconds and post-treated for 4 seconds (by spray) with a solution containing 2.2 g/l polyvinylphosphonic acid at 70° C., rinsed with demineralised water for 3.5 seconds and dried at 120° C. for 7 seconds. The support thus obtained was characterised by a surface roughness Ra of 0.35-0.4 μm (measured with interferometer NT1100) and an anodic weight of 3.0 g/m².

### Preparation of the Printing Plate Precursors PPP-01 to PPP-07

The printing plate precursors PPP-01 to PPP-07 were produced by coating each of the coating solution CS-01 to CS-07 onto the above described lithographic support. The coating solutions CS-01 to CS-07 contain the ingredients as defined in Table 1. The coating was applied at a wet coating thickness of approximately 25 μm and then dried at 125° C. for about 20 seconds. The dry coating weight amount in g/m² of each of the ingredients is indicated in Table 2.

Finally, the printing plate precursors, having a dry weight composition as indicated in Table 2, were aged at 50° C. for 24 hours.

TABLE 1
Composition of the coating solutions CS-01 to CS-07

| INGREDIENTS | CS-01 to CS-07 (in g) |
|---|---|
| Dowanol PM (1) | 735.00 |
| MEK (2) | 104.00 |
| Polyfox PF652NF | 51.00 |
| (50 wt. %) (3) | |
| PVAC-01 to PVAC-07 (4) | 71.38 |
| Crystal Violet (1 wt. %) (5) | 1.20 |
| SOO94 (6) | 1.32 |
| Quadrol (10 wt. %) (7) | 4.34 |
| 9900 LB (50 wt. %) (8) | 32.42 |
| (1) | Dowanol PM is polypropylene glycol monomethyl ether, i.e. 1-methoxy-2-propanol, commercially available from Dow |
| | Chemical Company; |
| (2) | MEK is 2-butanone; |
| (3) | Polyfox PF652NF is a solution of 50% by weight of a perfluorosurfactant, having a chemical structure as defined below, |
| | in Dowanol PM, commercially available from Omnova Solutions Inc.; this perfluoro surfactant has the following |
| | chemical structure: |

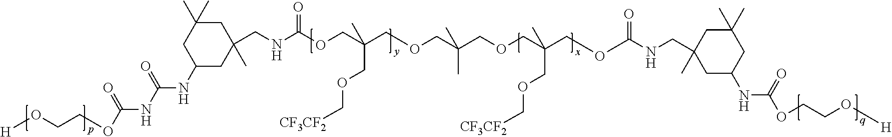

| | |
|---|---|
| | with a number average degree of polymerization x + y equal to approximately 10 and a number average degree of |
| | polymerization p + q equal to approximately 17.8; |
| (4) | PVAC-01 to PVAC-07 are polyvinylacetals, prepared by an acetalisation reaction of polyvinylalcohol as described in the |
| | description; in this reaction the polyvinylalcohol is polyvinylacetate, hydrolysed for 98%, the aldehyde for the first |
| | recurring unit is 2-hydroxy-benzaldehyde, and the aldehydes for the second and third recurring units are selected from |
| | butyraldehyde, propionaldehyde, valeraldehyde and octylaldehyde as indicated in Table 3, wherein also the amount of |
| | acetalisation by each aldehyde as determined with ¹³C NMR is indicated; |
| (5) | Crystal Violet is a solution of 1% by weight of Crystal Violet in Dowanol PM; Crystal Violet is commercially available from |
| | Ciba-Geigy GmbH; |
| (6) | SOO94 is an IR absorbing cyanine dye, commercially available from FEW CHEMICALS; SOO94 has the following |
| | chemical structure: |
| | 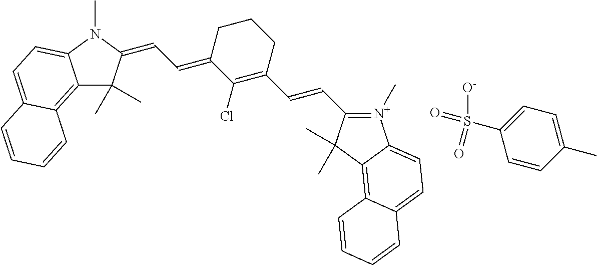 [SMILES: CN1/C(=C/C=C2\CCCC(/C=C/C3=[N+](C)c4ccc5ccccc5c4C3(C)C)=C2Cl)C(C)(C)c2c1ccc1ccccc21 ; Cc1ccc(S(=O)(=O)[O-])cc1] |
| (7) | Quadrol is a solution of 10% by weight of N,N,N′,N′-tetrakis(2-hydroxypropyl)ethylene diamine in Dowanol PM; this |
| | compound is commercially available as “Quadrol L” from BASF AG and has the following chemical structure: |
| | 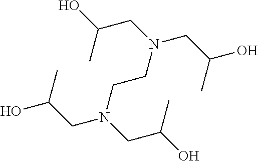 [SMILES: CC(O)CN(CCN(CC(C)O)CC(C)O)CC(C)O] |
| (8) | 9900 LB is a solution of 50% by weight of Bakelite PF9900LB in Dowanol PM; Bakelite PF9900 LB is a phenolic resin, |
| | commercially available from Hexion Specialty Chemicals AG. |

TABLE 2
Coating composition of precursors PPP-01 to PPP-07

| | Dry coating weight amount |
|---|---|
| | in PPP-01 to PPP-07 |
| INGREDIENTS | (in g/m²) |
| PVAC-01 to PVAC-07 | 709.4 |
| Crystal Violet | 27.0 |
| N,N,N′,N′-tetrakis(2- | 97.3 |
| hydroxypropyl)ethylene-diamine | |
| SOO94 | 29.6 |
| PolyFox PF652NF | 11.4 |
| Bakelite PF9900LB | 322.2 |
| Total | 1196.9 |

TABLE 3
Composition of PVAC-01 to PVAC-07 (in mole fractions)

| Poly- | First | Second | Third | | |
|---|---|---|---|---|---|
| vinyl- | recurring | recurring | recurring | | |
| acetal | unit | unit | unit | Vinyl | Vinyl |
| resin | (aldehyde) | (aldehyde) | (aldehyde) | acetate | alcohol |
| PVAC- | 43 | 21 | 0 | 3 | 33 |
| 01 | (2-hydroxy- | (butyraldehyde) | — | | |
| | benzaldehyde) | | | | |
| PVAC- | 50 | 10 | 10 | 2 | 28 |
| 02 | (2-hydroxy- | (butyraldehyde) | (valer- | | |
| | benzaldehyde) | | aldehyde) | | |
| PVAC- | 50 | 20 | 1 | 2 | 27 |
| 03 | (2-hydroxy- | (butyraldehyde) | (valer- | | |
| | benzaldehyde) | | aldehyde) | | |
| PVAC- | 52 | 20 | 1 | 2 | 25 |
| 04 | (2-hydroxy- | (butyraldehyde) | (octyl- | | |
| | benzaldehyde) | | aldehyde) | | |
| PVAC- | 47 | 20 | 1 | 2 | 29 |
| 05 | (2-hydroxy- | (butyraldehyde) | (propion- | | |
| | benzaldehyde) | | aldehyde) | | |
| PVAC- | 47 | 10 | 10 | 1 | 32 |
| 06 | (2-hydroxy- | (butyraldehyde) | (propion- | | |
| | benzaldehyde) | | aldehyde) | | |
| PVAC- | 49 | 16 | 4 | 2 | 29 |
| 07 | (2-hydroxy- | (butyraldehyde) | (propion- | | |
| | benzaldehyde) | | aldehyde) | | |

### Image-Wise Exposure

The printing plate precursors PPP-01 to PPP-07 are image-wise exposed at varying energy densities with a Creo Trendsetter, a platesetter having a 20 W thermal head, operating at 140 rpm and 2400 dpi, commercially available from Kodak.

### Developing Conditions

After image-wise exposure, the plate precursors are developed in an Agfa Autolith TP105 processor, commercially available from Agfa Graphics, with developer DEV-01 in the developer section and tap water at room temperature in the finisher section. The developer dwell time is 25 seconds and the developer temperature is in the range of 23 to 28° C. adapted for each printing plate precursor so as to result in similar development kinetics of the printing plate precursors.

The developer DEV-01 is made as follows:

To 600 ml. of demineralised water is added:

2 ml. of a 50 wt % solution of NaOH;
0.1 g of SAG220 Anti-Foam Emulsion, which is a polydimethylsiloxane emulsion in water (20 wt % active material), commercially available from Momentive Performance Materials Inc.;
115 g. of sodium metasilicate pentahydrate, commercially available from SILMACO N.V.;
4 g. of LiCl, commercially available from Aako BV;
4 g. of Akypo RLM-45CA, a 90 wt. % alcohol ether carboxylate surfactant solution, commercially available from Kao Chemicals GmbH, having the structure: polyoxyethylene(5) lauryl ether carboxylic acid;
7 g. of a 25 wt % solution of DETPM, i.e. diethylene triamine penta-(methylene phosphonic acid), commercially available from Rhodia Ltd. and having the following chemical structure:

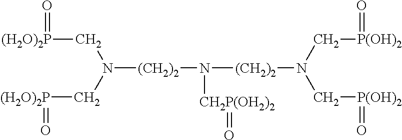

7 g. of Ralufon DCH, a coco alkyldimethyl(3-sulfopropyl)betaine, commercially available from Raschig GmbH;
28 g. of a 35 wt % solution of sodium silicate, commercially available from SILMACO N.V.;
demineralized water is added until 1000 ml. and, subsequently, a 50 wt. % solution of NaOH is added until the conductivity (at 25° C.) measures 86.0+/−0.2 mS/cm.

### Right Exposure Sensitivity

The right exposure, hereinafter also referred to as RE, is defined as that energy density (in mJ/cm²) which fits best with a 52% dot coverage on the plate when the precursor is exposed with a 1×1 checkerboard pattern and developed. The dot coverage is determined by measuring the optical density with a GretagMacbeth D19C densitometer (automatic colour filter setting), commercially available from Gretag-MacBeth.

The sensitivity is defined by the RE value and the lower the RE value, the higher is the sensitivity of the precursor. The results are summarized in Table 4.

### Developer Resistance

The developer resistance, hereinafter also referred to as DR, is determined by processing the resulting plate for a second time (identical processing conditions) and measuring the relative loss of the coating in a solid image area on the plate, referred to the original printing plate precursor.

The relative loss of the coating in the image area is assessed by measuring the relative loss of density with a Gretag-MacBeth D19C densitometer. A higher relative loss of density means a lower developer resistance. A value of relative loss of density ranging between 4% and 6% indicates a high developer resistance. The results are summarized in Table 4.

### Daylight Stability

The daylight stability, hereinafter also referred to as DS, is assessed for each of the printing precursors PPP-01 to PPP-07 through the following steps of the test procedure:
(1)—Uniform exposure of the precursor to a light source, as simulation for daylight exposure:
   The printing plate precursor is cut in seven pieces of 240 mm by 440 mm and each of these 7 pieces is exposed during a time period of respectively 0, 1, 2, 4, 8, 16 and 24 hours to light of the following light sources:
   The light from 2 fluorescent tubes of 58 W at a distance of 1.80 m from the precursor (ceiling): 1× Philips Fluorescent Tube 58W 840 Cool White and 1× Philips Fluorescent Tube 58W 830 Warm White; additionally 2 halogen light bulbs of 1000 W (Philips R7S 1000 W 189 mm R7S) in uplighters are positioned at a distance of 0.40 m from the ceiling in a way that their light only reaches the plate precursor in an indirect way (reflection from the white ceiling).

The light intensity at the surface of the precursor amounts to about 1300 Lux (as measured with a SkyTronic digital Lux meter).
(2)—Subsequently, each of these uniform light-exposed pieces is divided in seven parts, each of these parts is image-wise exposed on a Creo TrendSetter (commercially available from Kodak), operating with a 20 W imaging head at 140 rpm and 2400 dpi, at an energy density of respectively 80, 100, 120, 140, 160, 180 and 200 mJ/cm² and each part is image-wise exposed at a defined energy density with a test pattern comprising three areas, namely a blank area (0% dot coverage), a 1×1 pixel checkerboard area (50% dot coverage) and a 8×8 pixel checkerboard area (also 50% dot coverage).
(3)—Finally, these plate precursor pieces are developed as described before.
(4)—The daylight stability is evaluated by plotting the density of the 1×1 pixel checkerboard area (Gretag-MacBeth D19C densitometer) at an energy density level, which is as close as possible to its right exposure value, as a function of the daylight-exposure time period. The daylight stability value DS is the daylight-exposure to time period where the density of the 1×1 pixel checkerboard area falls to 33% of its original value, corresponding to 0 hours of daylight-exposure, determined by linear interpolation.

The results of this assessment for the precursors PPP-01 to PPP-07 are summarized in Table 4.

TABLE 4
Results of the Comparative Examples 1 to 4 and the
Invention Examples 1 to 3

| | | Right Exposure | Developer | Daylight |
|---|---|---|---|---|
| | | Sensitivity | Resistance | Stability |
| Example | | RE | DR | DS |
| Number | Precursor | (mJ/cm²) | (%) | (hours) |
| Comparative | PPP-01 | 172 | 5 | 10 |
| Example 1 | | | | |
| Comparative | PPP-02 | 177 | 5 | 7 |
| Example 2 | | | | |
| Comparative | PPP-03 | 174 | 4 | 8 |
| Example 3 | | | | |
| Comparative | PPP-04 | 187 | 5 | 9 |
| Example 4 | | | | |
| Invention | PPP-05 | 160 | 5 | 12 |
| Example 1 | | | | |
| Invention | PPP-06 | 156 | 6 | 19 |
| Example 2 | | | | |
| Invention | PPP-07 | 148 | 6 | 13 |
| Example 3 | | | | |

The results in Table 4 demonstrate that the precursors PPP-04 to PPP-07 comprising a polyvinylacetal binder in accordance with the present invention give an unexpected improvement of the RE-sensitivity of 148 to 160 mJ/cm² in comparison with the RE-value of 172 to 187 mJ/cm² for the comparative examples, which do not contain a polyvinylacetal binder as defined in the present invention.

In addition to the improved RE-sensitivity, the precursors PPP-04 to PPP-07 of the present invention also show an unexpected further improvement of the daylight stability DS-value of 12 to 19 hours, in comparison with the precursors PPP-01 to PPP-04 of the comparative examples which exhibit already a high daylight stability DS-value of 7 to 10 hours.

A high developer resistance DR, ranging between 4 and 6%, is observed for all the precursors.

1-15. (canceled)

16. A lithographic printing plate precursor comprising a support having a hydrophilic surface or which is provided with a hydrophilic layer, and a coating thereon, said coating comprising an IR absorbing agent and a polyvinylacetal, said polyvinylacetal comprising a first recurring unit comprising an acetal group having an acetal carbon atom substituted by a phenolic group, a naphthol group or an anthracenol group and a second recurring unit comprising an acetal group having an acetal carbon atom substituted by an alkyl group having a hydrocarbon chain containing 1, 2 or 3 carbon atoms, characterized in that said polyvinylacetal further comprises a third recurring unit comprising an acetal group having an acetal carbon atom substituted by an alkyl group having a hydrocarbon chain containing 1, 2 or 3 carbon atoms wherein the alkyl group of the acetal group of the third recurring unit is different from the alkyl group of the acetal group of the second recurring unit.

17. A lithographic printing plate precursor according to claim 16, wherein said hydrocarbon chain of the second recurring unit comprises 3 carbon atoms and said hydrocarbon chain of the third recurring unit comprises 1 or 2 carbon atoms.

18. A lithographic printing plate precursor according to claim 16, wherein said hydrocarbon chain of the second recurring unit comprises 3 carbon atoms and said hydrocarbon chain of the third recurring unit comprises 2 carbon atoms.

19. A lithographic printing plate precursor according to claim 16, wherein said acetal group of the first recurring unit has an acetal carbon atom substituted by a phenolic group.

20. A lithographic printing plate precursor according to claim 17, wherein said acetal group of the first recurring unit has an acetal carbon atom substituted by a phenolic group.

21. A lithographic printing plate precursor according to claim 18, wherein said acetal group of the first recurring unit has an acetal carbon atom substituted by a phenolic group.

22. A lithographic printing plate precursor according to claim 19, wherein said phenolic group of the first recurring unit is a 2-hydroxy-phenyl group.

23. A lithographic printing plate precursor according to claim 20, wherein said phenolic group of the first recurring unit is a 2-hydroxy-phenyl group.

24. A lithographic printing plate precursor according to claim 21, wherein said phenolic group of the first recurring unit is a 2-hydroxy-phenyl group.

25. A lithographic printing plate precursor according to claim 16, wherein the sum of the amounts (in mol % related to the complete polyvinylacetal) of the second and third recurring units in the polyvinylacetal ranges between 10 and 40 mol %.

26. A lithographic printing plate precursor according to claim 17, wherein the sum of the amounts (in mol % related to the complete polyvinylacetal) of the second and third recurring units in the polyvinylacetal ranges between 10 and 40 mol %.

27. A lithographic printing plate precursor according to claim 18, wherein the sum of the amounts (in mol % related to the complete polyvinylacetal) of the second and third recurring units in the polyvinylacetal ranges between 10 and 40 mol %.

28. A lithographic printing plate precursor according to claim 16, wherein the sum of the amounts (in mol % related to the complete polyvinylacetal) of the first, second and third recurring units in the polyvinylacetal ranges between 50 and 95 mol %.

29. A lithographic printing plate precursor according to claim 17, wherein the sum of the amounts (in mol % related to the complete polyvinylacetal) of the first, second and third recurring units in the polyvinylacetal ranges between 50 and 95 mol %.

30. A lithographic printing plate precursor according to claim 18, wherein the sum of the amounts (in mol % related to the complete polyvinylacetal) of the first, second and third recurring units in the polyvinylacetal ranges between 50 and 95 mol %.

31. A lithographic printing plate precursor according to claim 16, wherein the ratio of the amount (in mol % related to the complete polyvinylacetal) of the second recurring unit to the third recurring unit in the polyvinylacetal ranges between 100 and 0.01.

32. A lithographic printing plate precursor according to claim 17, wherein the ratio of the amount (in mol % related to the complete polyvinylacetal) of the second recurring unit to the third recurring unit in the polyvinylacetal ranges between 100 and 0.01.

33. A lithographic printing plate precursor according to claim 18, wherein the ratio of the amount (in mol % related to the complete polyvinylacetal) of the second recurring unit to the third recurring unit in the polyvinylacetal ranges between 100 and 0.01.

34. A lithographic printing plate precursor according to claim 16, wherein the ratio of the amounts (in mol % related to the complete polyvinylacetal) of the sum of the second and third recurring units to the first recurring unit in the polyvinylacetal ranges between 50 and 0.5.

35. A lithographic printing plate precursor according to claim 17, wherein the ratio of the amounts (in mol % related to the complete polyvinylacetal) of the sum of the second and third recurring units to the first recurring unit in the polyvinylacetal ranges between 50 and 0.5.

36. A lithographic printing plate precursor according to claim 18, wherein the ratio of the amounts (in mol % related to the complete polyvinylacetal) of the sum of the second and third recurring units to the first recurring unit in the polyvinylacetal ranges between 50 and 0.5.

37. A lithographic printing plate precursor according to claim 16, wherein the amount (in mol % related to the complete polyvinylacetal) of the first recurring unit in the polyvinylacetal is at least 30 mol %.

38. A lithographic printing plate precursor according to claim 17, wherein the amount (in mol % related to the complete polyvinylacetal) of the first recurring unit in the polyvinylacetal is at least 30 mol %.

39. A lithographic printing plate precursor according to claim 18, wherein the amount (in mol % related to the complete polyvinylacetal) of the first recurring unit in the polyvinylacetal is at least 30 mol %.

40. A lithographic printing plate precursor according to claim 16, wherein said coating further comprises a developability enhancing compound.

41. A lithographic printing plate precursor according to claim 17, wherein said coating further comprises a developability enhancing compound.

42. A lithographic printing plate precursor according to claim 18, wherein said coating further comprises a developability enhancing compound.

43. A lithographic printing plate precursor according to claim 40, wherein said developability enhancing compound is selected from N-(2-hydroxyethyl)-2-pyrrolidone, 1-(2-hydroxyethyl)piperazine, N-phenyldiethanolamine, triethanolamine, 2-[bis(2-hydroxyethyl)amino]-2-hydroxymethyl-1.3-propanediol, N,N,N′,N′-tetrakis(2-hydroxyethyl)-ethylenediamine, N,N,N′,N′-tetrakis(2-hydroxypropyl)-ethylenediamine, 3-[(2-hydroxyethyl)phenylamino]propionitrile, and hexahydro-1,3,5-tris(2-hydroxyethyl)-s-triazine.

44. A lithographic printing plate precursor according to claim 41, wherein said developability enhancing compound is selected from N-(2-hydroxyethyl)-2-pyrrolidone, 1-(2-hydroxyethyl)piperazine, N-phenyldiethanolamine, triethanolamine, 2-[bis(2-hydroxyethyl)amino]-2-hydroxymethyl-1.3-propanediol, N,N,N′,N′-tetrakis(2-hydroxyethyl)-ethylenediamine, N,N,N′,N′-tetrakis(2-hydroxypropyl)-ethylenediamine, 3-[(2-hydroxyethyl)phenylamino]propionitrile, and hexahydro-1,3,5-tris(2-hydroxyethyl)-s-triazine.

45. A lithographic printing plate precursor according to claim 42, wherein said developability enhancing compound is selected from N-(2-hydroxyethyl)-2-pyrrolidone, 1-(2-hydroxyethyl)piperazine, N-phenyldiethanolamine, triethanolamine, 2-[bis(2-hydroxyethyl)amino]-2-hydroxymethyl-1.3-propanediol, N,N,N′,N′-tetrakis(2-hydroxyethyl)-ethylenediamine, N,N,N′,N′-tetrakis(2-hydroxypropyl)-ethylenediamine, 3-[(2-hydroxyethyl)phenylamino]propionitrile, and hexahydro-1,3,5-tris(2-hydroxyethyl)-s-triazine.

46. A lithographic printing plate precursor according to claim 16, wherein said coating further comprises novolac.

47. A lithographic printing plate precursor according to claim 17, wherein said coating further comprises novolac.

48. A lithographic printing plate precursor according to claim 18, wherein said coating further comprises novolac.

49. A lithographic printing plate precursor according to claim 46, wherein the weight ratio of the polyvinylacetal to novolac ranges between 5 and 1.

50. A lithographic printing plate precursor according to claim 47, wherein the weight ratio of the polyvinylacetal to novolac ranges between 5 and 1.

51. A lithographic printing plate precursor according to claim 48, wherein the weight ratio of the polyvinylacetal to novolac ranges between 5 and 1.

52. A lithographic printing plate precursor according to claim 19, wherein the amount (in mol % related to the complete polyvinylacetal) of the first recurring unit in the polyvinylacetal is at least 30 mol %.

53. A lithographic printing plate precursor according to claim 20, wherein the amount (in mol % related to the complete polyvinylacetal) of the first recurring unit in the polyvinylacetal is at least 30 mol %.

54. A lithographic printing plate precursor according to claim 21, wherein the amount (in mol % related to the complete polyvinylacetal) of the first recurring unit in the polyvinylacetal is at least 30 mol %.

55. A method for making a lithographic printing plate comprising the steps of:
(1) providing a heat-sensitive lithographic printing plate precursor as defined in any of claim 16,
(2) image-wise exposing said precursor with IR-radiation or heat, and
(3) developing said image-wise exposed precursor.
